(19) United States
(12) Patent Application Publication
(10) Pub. No.: US 2010/0038809 A1
(43) Pub. Date: Feb. 18, 2010

(54) APPARATUS AND METHOD OF PRODUCING POROUS MEMBRANES

(76) Inventors: Gilbert Erskine, Lonsdale (AU); Jeff Norton, Lonsdale (AU); Craig Erskine, Lonsdale (AU)

Correspondence Address: WEINER & BURT, P.C., 635 N US-23, POB 186, HARRISVILLE, MI, 48740, US

(21) Appl. No.: 12/517,059

(22) PCT Filed: Jun. 13, 2007
(86) PCT No.: PCT/AU07/00828

§ 371 Date: Oct. 18, 2009

(30) Foreign Application Priority Data
Nov. 29, 2006 (AU) 2006906719

(51) Int. Cl. B29D 7/01; B29C 47/04

(52) U.S. Cl. 264/45.9; 425/67

(57) ABSTRACT

The present invention relates to an apparatus and method of producing lengths of multi-layered asymmetric membrane (10) by way of extruding different feedstock through a die head (46,78) having a plurality of outlet ports. The membrane (10) includes a plurality of apertures extending therethrough, and at least some of said apertures increase in cross-sectional area from a first surface of the membrane to a second surface of the membrane. The present invention provides a method of constructing membrane in desired lengths and reduces the need to weld portions of membrane together to produce extended lengths of membrane tube.

### FIELD OF THE INVENTION

The present invention relates to the production of filter membranes and in particular to multilayered metallic membranes including at least one layer adapted to filter particles in the micro and ultra range (0.001 microns to 100 microns).

### BACKGROUND OF THE INVENTION

Filter membranes are used in numerous industries to separate particulates from fluid and gas. The membranes can be constructed from various materials including plastic mesh, fine plastic tubes, porcelain or stainless steel mesh, depending on their application.

Membranes or indeed any other type of filtration media is purely a barrier to prevent the movement of particulates and bacteria. In theory, a membrane with single channel pore would be an ideal filter, however this is not commercially viable. What actually occurs in conventional filters, such as porcelain, is that the fluid is forced along a torturous path from the retentate side of the membrane to the permeate side. In the process particulate material is filtered out of the liquid. This has several disadvantages, for instance there is risk of permanent plugging from particulates being trapped within the membrane itself which makes it harder to clean.

Metallic membranes are used in a variety of industries for the separation of particulates in liquid or gas. Metallic membranes are robust and, depending on the metal used, can withstand both temperatures up to 900° C. and highly corrosive environments.

A current method of production of such filters involves a metal powder being loose gravity filled into a mould which has a solid mandrel and an elastomer outer. Once filled the mould is then placed into an isostatic press and compressed under pressure up to 60,000 psi, the resultant green compact, as it is referred to, is then sintered in at furnace having an inert atmosphere. This method produces a membrane with a substantially symmetric cross-sectional profile which suffers from similar permanent plugging issues as porcelain filters.

Another method of production utilises metallic mesh, however this method suffers from a number of drawbacks, including the fact that it is difficult to produce hole or pore sizes within the mesh to adequately filter small particles. Furthermore, it is difficult to produce a mesh with evenly spaced pores which limits the effective open area of the mesh.

In order to minimize these disadvantages and reduce the effects of permanent plugging, manufactures have attempted to perfect the use of a thin layer on the inside or outside of the filter wall. These filters include an outer support tube produced with varying grades of metallic powder. This outer tube is fired and a thin coat is applied to either the internal or external surface using a much finer powder and the filter is then re-fired. One of the problems which using such a method of production is that the layers can tend to laminate or separate due to the two step firing process.

It is therefore an object of the present invention to overcome at least some of the aforementioned problems or provide the public with a useful alternative.

It is yet a further object of the present invention to provide for an apparatus and method of producing lengths of porous asymmetric membrane.

### SUMMARY OF THE INVENTION

Therefore in one form of the invention there is proposed a method of producing a porous membrane, including the steps of:
providing at least one head die having a plurality of ports in communication with a plurality of respective hoppers, wherein each hopper contains a different mixture;
co-extruding at least some of the mixtures contained within the respective hoppers through the ports to thereby form a multilayered extrusion; and treatment of the multilayered extrusion to produce the porous membrane.

In preference the extrusion is immersed is a liquid once it has emerged from the die head.

In preference the cross-sectional profile of the membrane is asymmetric.

Preferably the treatment includes the sintering of the multilayered extrusion in a furnace.

Alternatively the treatment is a chemical treatment.

In preference the mixtures in the hoppers include a powder/binder feedstock.

More preferably the size of the powder is in a range from 0.001 μm to 500 μm. This depends on the end product and/or application.

Preferably the different mixtures contain powders of different materials.

In preference the different powders have different melting points.

More preferably the mixture used to produce a first layer contains a powder having a first melting point and the mixture used to produce a second layer contains a powder having a second melting point.

Most preferably the first melting point is higher than the second melting point.

Preferably the powder is produced by way of various processes including, but not limited to, water-atomization, gas-atomization, plasma rotating electrode, vacuum atomization, rotating disk atomization, ultrarapid solidification, ultrasonic atomization, centrifugal atomization and carbonyl process.

Preferably the powder is selected from a group containing but not limited to metallic, non-metallic and inter-metallic materials.

More preferably the powder is selected from a group containing stainless steel, nickel, titanium, titanium dioxide, vanadium dioxide, tungsten carbide, and silicon nitride.

Preferably the feedstock further includes an aqueous or non-aqueous binder or a mixture of both.

In preference the binder is selected from a group containing but not limited to, polyethylene, cellulose acetate, polyamide, polysulfone, methyl cellulose, agar and polypropylene.

More preferably the solvent is selected from a group containing acetone, n-methyl pyrrolidone, water or formamide.

Most preferably the binder-solvent mixture is weighted out to a ratio between 2:8 and 9:1. Depending on material to be mixed with the binder-solvent mixture.

Preferably the resultant membrane is hydrophobic.

Alternatively the resultant membrane is hydrophilic.

In a further form of the invention there is proposed an assembly for producing a porous membrane, including:
a plurality of hoppers adapted to accommodate different mixtures; and
at least one die head contain a plurality of ports in communication with said hoppers;
whereby at least some of the mixtures contained within the respective hoppers are co-extruded through the ports to thereby form a multilayered extrusion.

Preferably the multilayered extrusion is treated to produce a porous membrane.

Preferably each port is connected to a single hopper.

In preference the assembly further includes a variable pressure feed system.

More preferably the extrusion is extruded in a tubular form.

In yet a further form of the invention there is proposed a membrane produced using the above method.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a perspective view of the porous membrane produced using the method of the present invention;

FIG. 2 is a perspective view of a first embodiment of an assembly adapted to extrude a multilayered extrusion which when treated produces the porous membrane of FIG. 1;

FIG. 3 is a top view of the assembly of a FIG. 2;

FIG. 4a is a perspective view of a second embodiment of die head adapted to extrude the multilayered extrusion which when treated produces the porous membrane of FIG. 1; and

FIG. 4b is an end view of the die head of FIG. 4a.

### DESCRIPTION OF THE PREFERRED EMBODIMENTS

Although the following detailed description includes exemplary embodiments, other embodiments are possible, and changes may be made to the embodiments described without departing from the spirit and scope of the invention.

The method of the present invention relates to the extrusion of membranes, with two or more layers, into lengths between 0.05 m up to 8 m. The invention provides a method of co-extruding a tube, sheet or any 3 dimensional shape in two or more layers of metallic powder mixed with binder to produce an asymmetric membrane. In this way the invention avoids the need to gravity fill the metal powder into a mould and overcomes many of the limitations of the prior art.

The apparatus includes a die head with a plurality of ports through which various mixtures are co-extruded to form a multi-layered length of green or unfired membrane. It should however be appreciated by the skilled addressee that not all ports need to be used during production of the membrane. For instance one port can be used to produce the end cap portion used to weld lengths of membrane together. In a preferred embodiment the mixtures that are to be extruded out of the ports incorporate metallic powder with particles having a size in the range from 0.001 μm to 500 μm. It should however be appreciated that any metallic, non-metallic or inter-metallic material could be used, such as stainless steel, nickel, titanium, titanium dioxide, vanadium dioxide, tungsten carbide, silicon nitride, oxides or ceramic.

The powder can be produced from various processes including, but not limited to, water-atomization, gas-atomization, plasma rotating electrode, vacuum atomization, rotating disk atomization, ultrarapid solidification, ultrasonic atomization, centrifugal atomization and carbonyl process.

To be able to produce an extruded asymmetric membrane the different layers contain metal powder of different sizes and melting points. This reduces the active filter layer thickness which in turn gives higher permeability. Depending on the application to which the membrane is applied, for the purpose of this description, stainless steel 316L, nickel-based superalloys, tungsten and titanium are used. Furthermore for the purposes of the description it is envisaged that the membrane will be produced in a tubular form.

The metallic powder mix further includes a binder and a solvent which are mixed together until the binder has completely dissolved in the solvent. It is envisaged that the binder will be selected from a group containing, polyethylene, cellulose acetate, polyamide, polysulfone, methyl cellulose, agar and polypropylene. The solvent can be selected from a group containing acetone, n-methyl pyrrolidone, water or formamide.

In a preferred embodiment the binder is polysulphone, with the solvent being N-methyl pyrrolidone at a ratio of 6:10 by weight.

The binder-solvent mixture is weighted out to a ratio between 2:8 and 9:1, depending on which layer is to be extruded. By lowering the ratio of solvent the viscosity of the resultant mixture can be increased. The binder-solvent is then mixed for a time period between 10 minutes to 30 hours. A binder bead and a solvent are mixed together until the binder bead has completely dissolved in the solvent.

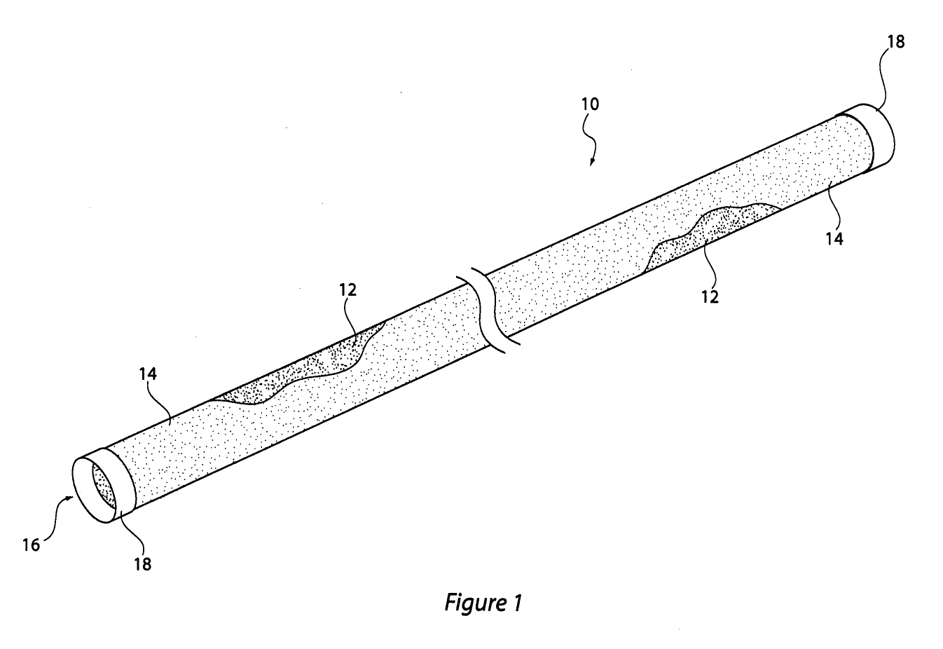

Turning to the drawings for a more detailed description there is illustrated a filter membrane 10, demonstrating by way of example one arrangement in which the principles of the present invention may be employed. FIG. 1 illustrated the filter membrane 10 includes an inner layer 12 and an outer layer 14. The inner layer 12 is constructed using a material having smaller particles size and a higher melting point than that of the outer layer 14. The membrane 10 is tubular in construction with a longitudinally extended passageway 16 and includes an end portion 18 used to join membrane lengths together to form a desired length. The end portions 18 are joined by welding as is known in the art.

The filter membrane 10, formed using the method of the present invention, has apertures that increase in cross-sectional area as the apertures extend from one side of the membrane to the opposing side. This increase in the cross-sectional area of the apertures is produced by having a plurality of layers formed using material of increasing grain or particle size. Accordingly, the metallic powder having the smallest grain size is used in the layer which is configured to be in direct contact with the unfiltered solution.

The reader will appreciate that by using powders having specific sizes an aperture matrix is formed wherein the cross-sectional area of the apertures increase as the apertures extend from the inside surface of the tube to the outside surface.

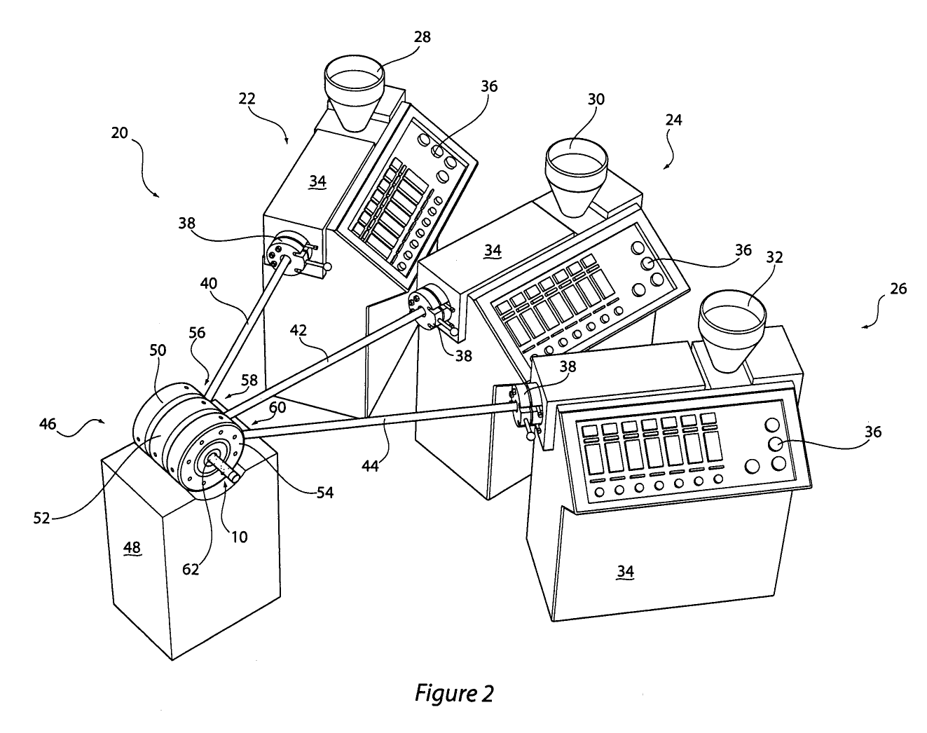

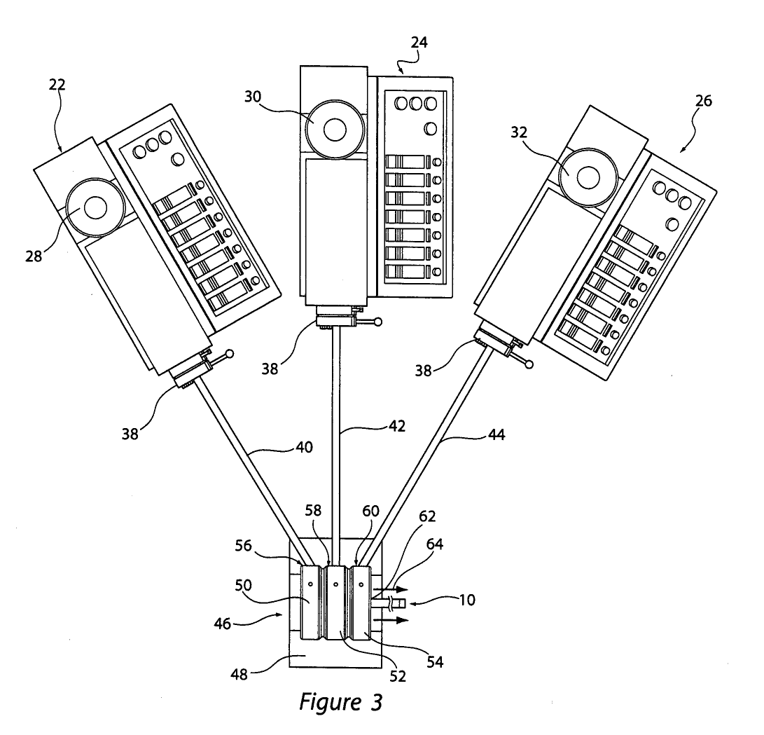

FIGS. 2 and 3 illustrate the assembly 20 for producing the filter membrane 10 including extrusion apparatus 22, 24 and 26 having respective hoppers 28, 30 and 32. Each extrusion apparatus includes a housing 34, control panel 36 and outlet 38. Each outlet 38 is configured to eject a solid stream of pliable mixture. Shafts 40, 42 and 44 are extruded out of respective apparatus 22, 24 and 26.

The shafts 40, 42 and 44 pass into a die head member 46. The reader should appreciate that the assembly may include an intermediate member (not shown) for supporting the pliable shafts. The die head 46 is supported on a stand 48 and includes elements 50, 52 and 54 having respective inlets 56, 58, 60. The die head further includes an outlet 62 which comprises a plurality of ports (not shown). The die head 46 may include any number of ports depending upon the how many layers are required.

The extrusion is then placed in a controlled atmosphere furnace to be sintered thereby producing the filter membrane 10. The furnace typically produces pressures of between 10 and −2 mbar and maximum temperatures ranging from 1180° C. and 1240° C. During the heating process back-fill gas is introduced. This gas is a combination of hydrogen/argon and nitrogen. The skilled addressee should however appreciate that the invention is not limited to these sintering conditions and the pressure, temperature and holding time can be varied depending on the type of membrane being produced.

By using powders having different melting points the extrusion is able to be sintered without running the risk of shutting off of the membrane. The skilled addressee would appreciate that if all the powders had the same melting point then the fine powder in the thin inner layer would merge into the thicker outer layer, since the thinner layer would melt first. This would effectively produce a solid inner surface thereby rendering the membrane useless. Therefore it is envisaged that the powder used in the inner layer would have a smaller particle size and higher melting point than the powder used in the outer layer. Accordingly, by controlling both the particle size of the powder and its melting point a multilayered membrane can be produced.

Although the cross-section of the tubular member is illustrated as circular, it is envisaged that the cross-sectional profile could be a triangular, hexagon or any other type of polygon.

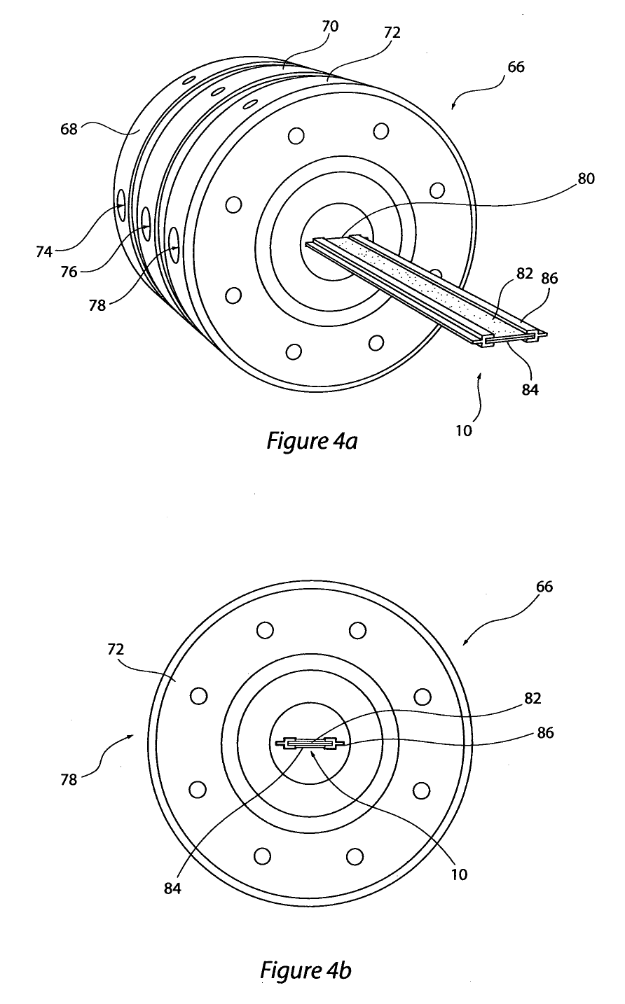

Alternatively the present invention can be used to produce sheet membrane of different widths and lengths. For instance, as illustrated in FIGS. 4a and 4b, a die head 66 includes elements 68, 70 and 72 having respective inlets 74, 76 and 78. The die head includes an outlet 80 which comprises a plurality of ports (not shown), such that in use, a membrane 10 is extruded that includes layers 82 and 84 and side portions 86 used to join membrane lengths together to form a desired width.

To further explain the present invention a die head including six ports is envisaged, which is configured to produce an extrusion of a tubular form. It should be appreciated that, in use, not all ports need to be used during production of the membrane 10. In this way a single die head 46 can be utilised to produce membranes of varying numbers of layers.

To assist in the explanation of this embodiment the different layers of the membrane and the port through which they are extruded will now be described.
Layer one, which is extruded out of port one is the active filter layer and includes powder having the smallest particle size, usually between 0.001 μm to 5 μm.
Layer two, which is extruded out of port two, is an intermediate layer which uses metal powder in the range of 3 μm to 16 μm.
Layer three, which is extruded out of port three, is also an intermediate layer which uses metal powder in the range of 10 μm to 30 μm.
Layer four, which is extruded out of port four, is also an intermediate layer which uses metal powder in the range of 22 μm to 44 μm.
Layer five, which is extruded out of port five, is the outer support layer which uses metal powder in the range of 30 μm to 500 μm.
Port six is not used to extrude an active layer of the membrane rather it is used to supply material to the terminal ends of the membrane tube. After being fired in a furnace the material extruded out of port six is nearly solid. This solid portion at the terminal ends of the membrane tube facilitates joining or welding to desired configuration. The material extruded out of port six includes fine metal powder in the range of 0.01 μm to 10 μm.

### Example 1

The following is a detailed description of the method of manufacture of a five layer tubular membrane using the above die head having six ports.

Five layers are produced using mixtures containing particles of different sizes. The following is an explanation of the mixtures that are used to produce the various layers and the ports through which they are co-extruded. Each port is supplied by an individual feed hopper with a variable pressure feed system.

Layer one is produced from a mixture extruded out through port one containing tungsten powder with a micron size between 0.1 μm to 6.0 μm preferably 0.6-1.0 μm. The powder and a binder-solvent are combined at a ratio of between 1:1 and 7:3 by volume, preferably 7:3 and processed to produce a suitable feed stock ready for use.

Layer two is produced from a mixture extruded out through port two containing stainless steel 316L powder with a micron size between 5.0 μm to 22.0 μm preferably 16.0 μm. The powder and a binder-solvent are combined at a ratio of between 1:1 and 7:3 by volume, preferably 6:4 and processed to produce a suitable feed stock ready for use.

Layer three is produced from a mixture extruded out through port three containing stainless steel 316L powder with a micron size between 10.0 μm to 30.0 μm preferably 22.0 μm. The powder and a binder-solvent are combined at a ratio of between 1:1 and 7:3 by volume, preferably 6.5:3.5 and processed to produce a suitable feed stock ready for use.

Layer four is produced from a mixture extruded out through port four containing stainless steel 316L powder with a micron size between 22.0 μm to 44.0 μm preferably 37.0 μm. The powder and a binder-solvent are combined at a ratio of between 1:1 and 7:3 by volume, preferably 1:1 and processed to produce a suitable feed stock ready for use.

Layer five is produced from a mixture extruded out through port five containing stainless steel 316L powder with a micron size between 30.0 μm to 500.0 μm preferably 80.0 μm. The powder and a binder-solvent are combined at a ratio of between 1:1 and 7:3 by volume, preferably 1:1 and processed to produce a suitable feed stock ready for use.

The mixture extruded out through port six contains stainless steel 316L powder with a micron size between 1.0 μm to 5.0 μm preferably 3.5 μm. The powder and a binder-solvent are combined at a ratio of between 1:1 and 7:3 by volume, preferably 6.5:3.5 and processed to produce a suitable feed stock ready for use.

On completion of mixing the powder-binder-solvent, the feedstock is placed in the appropriate feed hopper. This is then fed at high pressure to the die head to form a multi-layered extrusion. Upon exiting the die head the extrusion is placed into a solution for curing of the binder-solvent component thus creating a rigid hard green membrane. The green compact is then sintered in a furnace to form a porous filter membrane.

The following is an explanation of the pores sizes of the resultant layers.

Layer one, port one; at the die head will give an active filter layer ranging between 1 μm and 300 μm depending upon the intended end use of the filter.

Layer two, port two; at the die head will give an active filter layer ranging between 5 μm and 300 μm depending upon the intended end use of the filter.

Layer three, port three; at the die head will give an active filter layer ranging between 10 μm and 300 μm depending upon the intended end use of the filter.

Layer four, port four; at the die head will give an active filter layer ranging between 22 μm and 300 μm depending upon the intended end use of the filter.

Layer five, port five; at the die head will give a support medium for the other four layers ranging between 100 μm and 3 mm depending upon the intended end use of the filter.

Mixture extruded out of port six; at the die head will give a thickness ranging between 100 μm to 4 mm this will enhance connectivity or weld-ability of membrane to housings, fittings or other lengths of membrane tube as required.

### Example 2

The following is a detailed description of the manufacture of a three layer tubular membrane using the above die head having six ports. It should be appreciated that in this example ports 4 and 5 are not used during production of the membrane.

Three layers are produced using mixtures containing particles of different sizes. The following is an explanation of the mixtures that are used to produces the various layers and the ports through which they are co-extruded. Each port is supplied by an individual feed hopper with a variable pressure feed system.

Layer one is produced from a mixture extruded out through port one containing tungsten powder with a micron size between 0.1 μm to 6.0 μm preferably 0.6-1.0 μm. The powder and a binder-solvent are combined at a ratio of between 1:1 and 7:3 by volume, preferably 7:3 and processed to produce a suitable feed stock ready for use.

Layer two is produced from a mixture extruded out through port two containing stainless steel 316L powder with a micron size between 5.0 μm to 22.0 μm preferably 16.0 μm. The powder and a binder-solvent are combined at a ratio of between 1:1 and 7:3 by volume, preferably 6:4 and processed to produce a suitable feed stock ready for use.

Layer three is produced from a mixture extruded out through port three containing stainless steel 316L powder with a micron size between 22.0 μm to 44.0 μm preferably 37.0 μm. The powder and a binder-solvent are combined at a ratio of between 1:1 and 7:3 by volume, preferably 1:1 and processed to produce a suitable feed stock ready for use.

The mixture extruded out through port six contains stainless steel 316L powder with a micron size between 1.0 μm to 5.0 μm preferably 3.5 μm. The powder and a binder-solvent are combined at a ratio of between 1:1 and 7:3 by volume, preferably 6.5:3.5 and processed to produce a suitable feed stock ready for use.

On completion of mixing the powder-binder-solvent, the feedstock is placed in the appropriate feed hopper. This is then fed at high pressure to the die head to form a multi-layered extrusion. Upon exiting the die head the extrusion is placed into a solution for curing of the binder-solvent component thus creating a rigid hard green membrane which can then be sintered as is well known in the art.

The following is an explanation of the pores sizes of the resultant layers.

Layer one, port one; at the die head will give an active filter layer ranging between 0.6 μm and 300 μm depending upon the intended end use of the filter.

Layer two, port two; at the die head will give an active filter layer ranging between 20 μm and 300 μm depending upon the intended end use of the filter.

Layer three, port three; at the die head will give an active filter layer greater than 20 μm depending upon the intended end use of the filter.

Mixture extruded out of port six; at the die head will give a thickness ranging between 100 μm to 4 mm, this will enable full seal between the filtrate and retentate sides of the membrane when joining of the tube is undertaken.

### Example 3

The following is a detailed description of the manufacture of a two layer tubular membrane using the above die head having six ports. It should be appreciated that in this example ports 3, 4 and 5 are not used during production of the membrane.

Two layers are produced using mixtures containing particles of different sizes. The following is an explanation of the mixtures that are used to produces the various layers and the ports through which they are co-extruded. Each port is supplied by an individual feed hopper with a variable pressure feed system.

Layer one is produced from a mixture extruded out through port one containing tungsten powder with a micron size between 0.1 μm to 6.0 μm preferably 0.6-1.0 μm. The powder and a binder-solvent are combined at a ratio of between 1:1 and 7:3 by volume, preferably 7:3 and processed to produce a suitable feed stock ready for use.

Layer two is produced from a mixture extruded out through port two containing stainless steel 316L powder with a micron size between 22.0 μm to 44.0 μm preferably 37.0 μm. The powder and a binder-solvent are combined at a ratio of between 1:1 and 7:3 by volume, preferably 1:1 and processed to produce a suitable feed stock ready for use.

The mixture extruded out through port six contains stainless steel 316L powder with a micron size between 1.0 μm to 5.0 μm preferably 3.5 μm. The powder and a binder-solvent are combined at a ratio of between 1:1 and 7:3 by volume, preferably 6.5:3.5 and processed to produce a suitable feed stock ready for use.

On completion of mixing the powder-binder-solvent, the feedstock is placed in the appropriate feed hopper. This is then fed at high pressure to the die head to form a multi-layered extrusion. Upon exiting the die head the extrusion is placed into a solution for curing of the binder-solvent component thus creating a rigid hard green membrane which is then sintered as is well known in the art.

The following is an explanation of the pore sizes of the resultant layers.

Layer one, port one; at the die head will give an active filter layer ranging between 0.6 μm and 300 μm depending upon the intended end use of the filter.

Layer two, port two; at the die head will give an active filter layer ranging between 100 μm to 4 mm depending upon the intended end use of the filter.

Mixture extruded out of port six; at the die head will give a thickness ranging between 100 μm to 4 mm, this will enable full sealing between the filtrate and retentate sides of the membrane when joining of the tube is undertaken.

Depending upon the intended use the membrane can be either hydrophobic or hydrophilic. This can be accomplished by the additional of hydrophobic or hydrophilic substances into the different mixtures. As the skilled addressee will appreciate hydrophobic membranes are useful in filtering oils, bio-diesels and the like. On the other hand hydrophilic membranes are useful in separating fruit juice and wine since it can potentially increase flow rates by a factor or four.

The skilled addressee will now appreciate the many advantages of the present invention. The invention provides a method for producing asymmetric metallic membranes with varying micron ratings of long lengths compared with membranes produced using currently available methods. The invention eliminates laminating of the membrane or shutting off of the membrane during sintering, due to its unique method of production.

The unique way of applying the different layers ensures that there is no mixing and means that regular pore spacing can be maintained. The reader will appreciate that being able to produce long lengths of membrane tube means that less welding is required when the membrane is installed. This minimises interruptions in the membrane surface which reduces overall usable filter surface area. Furthermore it reduces possible points of weakness which may result in undesirable leakage.

Any discussion of the prior art throughout the specification should in no way be considered as an admission that such prior art is widely known or forms part of the common general knowledge in this field.

Further advantages and improvements may very well be made to the present invention without deviating from its scope. Although the invention has been shown and described in what is conceived to be the most practical and preferred embodiment, it is recognized that departures may be made therefrom within the scope and spirit of the invention. Although it is envisaged that the present invention is directed towards the production of membrane in the 0.001 micron to 100 micron range the invention is not limited to this particular size range.

In the summary of the invention and the claims that follow, except where the context requires otherwise due to express language or necessary implication, the word “comprising” is used in the sense of “including”, i.e. the features specified may be associated with further features in various embodiments of the invention.

1. A method of producing a porous membrane, including the steps of:
providing at least one head die having a plurality of ports in communication with a plurality of respective hoppers, wherein each hopper contains a different mixture;
co-extruding at least some of the mixtures contained within the respective hoppers through the ports to thereby form a multilayered extrusion; and
treating the multilayered extrusion to produce the porous membrane.

2. The method of producing a porous membrane according to claim 1 wherein the extrusion is immersed is a liquid once it has emerged from the die head.

3. The method of producing a porous membrane according to claim 1 wherein the cross-sectional profile of the membrane is asymmetric.

4. The method of producing a porous membrane according to claim 1 wherein the treatment includes the sintering of the multilayered extrusion in a furnace.

5. (canceled)

6. The method of producing a porous membrane according to claim 1 wherein the mixtures in the hoppers include a powder/binder feedstock.

7. The method of producing a porous membrane according to claim 6 wherein the size of the powder is in a range from 0.001 μm to 500 μm.

8. The method of producing a porous membrane according to claim 1 wherein the mixtures contain different powders of different materials and/or of different melting points

9. (canceled)

10. The method of producing a porous membrane according to claim 1 wherein the mixture used to produce a first layer contains a powder having a first melting point and the mixture used to produce a second layer contains a powder having a second melting point and wherein the first melting point is higher than the second melting point.

11. (canceled)

12. The method of producing a porous membrane according to claim 6 wherein the powder is produced by way of various processes including, but not limited to, water-atomization, gas-atomization, plasma rotating electrode, vacuum atomization, rotating disk atomization, ultrarapid solidification, ultrasonic atomization, centrifugal atomization and carbonyl process.

13. (canceled)

14. The method of producing a porous membrane according to claim 6 wherein the powder is selected from a group containing stainless steel, nickel, titanium, titanium dioxide, vanadium dioxide, tungsten carbide, and silicon nitride.

15. The method of producing a porous membrane according to claim 6 wherein the feedstock includes an aqueous or non-aqueous binder or a mixture of both.

16. The method of producing a porous membrane according to claim 15 wherein the binder is selected from a group containing but not limited to, polyethylene, cellulose acetate, polyamide, polysulfone, methyl cellulose, agar and polypropylene.

17. The method of producing a porous membrane according to claim 1 wherein the mixture includes a solvent selected from a group containing acetone, n-methyl pyrrolidone, water or formamide.

18. The method of producing a porous membrane according to claim 17 wherein the binder-solvent mixture is weighted out to a ratio between 2:8 and 9:1 depending on material to be mixed with the binder-solvent mixture.

19. The method of producing a porous membrane according to claim 1 wherein the resultant membrane is hydrophobic.

20. The method of producing a porous membrane according to claim 1 wherein the resultant membrane is hydrophilic.

21. An assembly for producing a porous membrane, including: a plurality of hoppers adapted to accommodate different mixtures; and at least one die head contain a plurality of ports in communication with said hoppers; whereby at least some of the mixtures contained within the respective hoppers are co-extruded through the ports to thereby form a multilayered extrusion.

22. (canceled)

23. The assembly for producing a porous membrane according to claim 21 wherein each port is connected to a single hopper.

24. The assembly for producing a porous membrane according to claim 21 wherein the assembly further includes a variable pressure feed system.

25-28. (canceled)

29. A product produced by the method of claim 1.
